(19) United States
(12) Patent Application Publication
(10) Pub. No.: US 2026/0299942 A1
(43) Pub. Date: Oct. 1, 2026

(54) MICROCONTROLLER, CONTROL SYSTEM, AND CONTROL METHOD

(71) Applicant: Nuvoton Technology Corporation, Hsinchu Science Park (TW)

(72) Inventors: Wubin YANG, Shenzhen (CN); Chieh-Sheng TU, Hsinchu Science Park (TW); Anming ZHANG, Shenzhen (CN)

(21) Appl. No.: 19/577,881

(22) Filed: Mar. 25, 2026

(30) Foreign Application Priority Data
Mar. 27, 2025 (CN) 202510373530.9

(51) Int. Cl. G06F 9/22; G06F 13/40

(52) U.S. Cl. CPC G06F 9/226; G06F 13/4022

(57) ABSTRACT

A microcontroller coupled to an external device which provides a plurality of sampled signals is provided. The microcontroller includes an input-output interface, a conversion circuit, a control circuit, a storage circuit, and a central processing unit (CPU) circuit. The input-output interface outputs a switching signal to the external device and receives the sampled signals. The conversion circuit converts the sampled signals to generate a plurality of converted signals. The control circuit generates and adjusts the switching signal. The storage circuit stores the converted signals. The CPU circuit operates according to the converted signals stored in the storage circuit in response to an interrupt signal being enabled. In response to a specific event occurring, the control circuit enables the interrupt signal.

### CROSS REFERENCE TO RELATED APPLICATIONS

This Application claims priority of China Patent Application No. 202510373530.9, filed on Mar. 27, 2025, the entirety of which is incorporated by reference herein.

### TECHNICAL FIELD

The present disclosure relates to a microcontroller, and, in particular, it relates to a microcontroller for collecting sampled signals.

### BACKGROUND

Sampled signals may be provided in some peripheral devices such as keyboards. A control chip collects and converts the sampled signals of a peripheral device. However, when a peripheral device provides a large number of sampled signals, a single control chip may not be able to process all the sampled signals. The conventional method uses multiple control chips to process a large number of sampled signals, but component costs have increased.

### BRIEF SUMMARY

An embodiment of the present disclosure provides a microcontroller coupled to an external device which provides a plurality of sampled signals. The microcontroller comprises an input-output interface, a conversion circuit, a control circuit, a storage circuit, and a central processing unit (CPU) circuit. The input-output interface outputs a switching signal to the external device and receives the sampled signals. The conversion circuit converts the sampled signals to generate a plurality of converted signals. The control circuit generates and adjusts the switching signal. The storage circuit stores the converted signals. The CPU circuit operates according to the converted signals stored in the storage circuit in response to an interrupt signal being enabled. In response to a specific event occurring, the control circuit enables the interrupt signal.

An embodiment of the present disclosure provides a control system. The control system comprises an external device and a microcontroller. The external device comprises a plurality of buttons, a plurality of sensors, and a switch circuit. Each sensor detects the pressed state of one of the buttons to generate a sampled signal. The switch circuit outputs the sampled signals according to a switching signal. The microcontroller comprises an input-output interface, a conversion circuit, a control circuit, a storage circuit, and a CPU circuit. The input-output interface outputs the switching signal to the switch circuit and receives the sampled signals. The conversion circuit converts the sampled signals to generate a plurality of converted signals. The control circuit generates and adjusts the switching signal. The storage circuit stores the converted signals. The CPU circuit operates according to the converted signals stored in the storage circuit in response to an interrupt signal being enabled. In response to a specific event occurring, the control circuit enables the interrupt signal.

A control method for a peripheral direct memory access (PDMA) circuit is provided. An exemplary embodiment of the control method is described in the following paragraph. A switching signal is generated. The switching signal is provided to an external device. A conversion circuit is triggered to convert a first sampled signal from the external device. A determination is made as to whether a specific event occurs. In response to the specific event not occurring, the output of the conversion circuit is stored to a storage circuit, the external device is controlled to output a second sampled signal, the second sampled signal is converted, and a determination is made as to whether the specific event occurs. In response to the specific event occurring, the output of the conversion circuit is stored in the storage circuit, an interrupt signal is sent to a CPU circuit so that the CPU circuit operates according to the data stored in the storage circuit.

Control method may be practiced by the systems which have hardware or firmware capable of performing particular functions and may take the form of program code embodied in a tangible media. When the program code is loaded into and executed by an electronic device, a processor, a computer or a machine, the electronic device, the processor, the computer or the machine becomes a microcontroller and a control circuit for practicing the disclosed method.

### BRIEF DESCRIPTION OF THE DRAWINGS

The present disclosure can be more fully understood by reading the subsequent detailed description and examples with references made to the accompanying drawings, wherein:

FIG. 1 is a schematic diagram of an exemplary embodiment of a control system according to various aspects of the present disclosure;

FIG. 2 is a schematic diagram of an exemplary embodiment of a microcontroller according to various aspects of the present disclosure;

FIG. 3 is a flowchart of an exemplary embodiment of a control method in accordance with an embodiment of the present disclosure;

FIG. 4 is a schematic diagram of an exemplary embodiment of an external device according to various aspects of the present disclosure;

FIG. 5 is a schematic diagram of another exemplary embodiment of the microcontroller according to various aspects of the present disclosure; and

FIG. 6 is a flowchart of another exemplary embodiment of the control method in accordance with an embodiment of the present disclosure.

### DETAILED DESCRIPTION

The present disclosure will be described with respect to particular embodiments and with reference to certain drawings, but the disclosure is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the present disclosure.

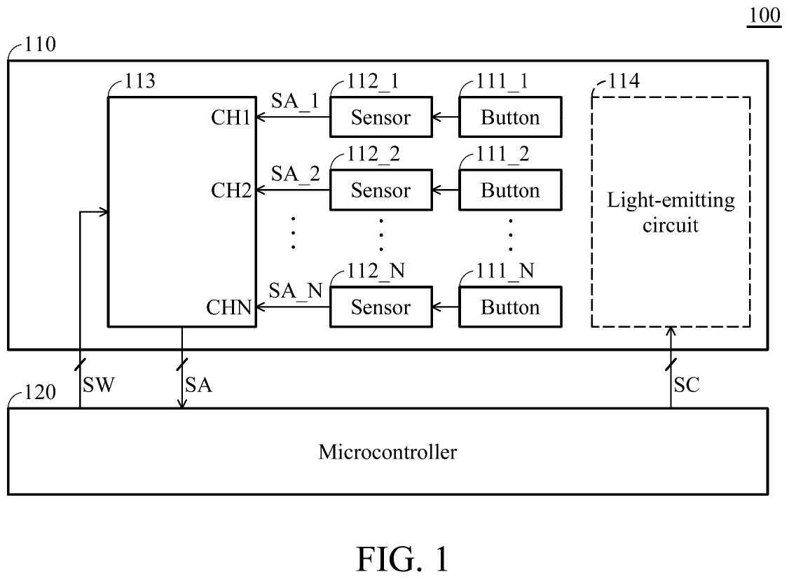

FIG. 1 is a schematic diagram of an exemplary embodiment of a control system according to various aspects of the present disclosure. As shown in FIG. 1, the control system 100 comprises an external device 110 and a microcontroller (MCU) 120. The external device 110 outputs a sampled signal SA to the microcontroller 120 according to a switching signal SW. In one embodiment, the external device 110 comprises multiple channels. Each channel transmits a sampled signal. In this case, the external device 110 provides sampled signals from different channels to the microcontroller 120 according to different switching signals.

The circuit structure of the external device 110 is not limited in the present disclosure. In one embodiment, the external device 110 comprises buttons 111_1~111_N, sensors 112_1~112_N, and a switch circuit 113. The number or type of buttons 111_1~111_N is not limited in the present disclosure. The buttons 111_1~111_N may be membrane buttons, mechanical buttons, optical-axis buttons, magnetic-axis buttons, or electrostatic-capacitive buttons.

Each sensor corresponds to a button and detects the pressed state of the corresponding button to generate a sampled signal. For example, the sensor 112_1 corresponds to the button 111_1, and the sensor 112_2 corresponds to the button 111_2. In this case, the sensor 112_1 detects the pressed state of the button 111_1 (e.g., whether the button 111_1 is pressed, or the force with which the button 111_1 is pressed) to generate a sampled signal SA_1. Similarly, the sensor 112_2 detects the pressed state of the button 111_2, to generate a sampled signal SA_2. The types of sensors 112_1~112_N are not limited in the present disclosure. Any sensor capable of detecting the pressed state of the buttons 111_1~111_N can be used as the sensor 112_1~112_N. For example, when the buttons 111_1~111_N are magnetic-axis buttons, the sensors 112_1~112_N are Hall sensors. In this example, the sampled signals SA_1~SA_N are analog signals. In other embodiments, the sampled signals SA_1~SA_N are digital signals.

The switch circuit 113 comprises multiple channels CH_1~CH_N for receiving sampled signals SA_1~SA_N. In this case, the switch circuit 113 uses one of the sampled signals SA_1~SA_N as the sampled signal SA according to the switching signal SW. In one embodiment, the switch circuit 113 is an analog switch. In this case, the switch circuit 113 uses the sampled signal from different channels as the sampled signal SA according to different switching signals SW.

In other embodiments, the external device 110 further comprises a light-emitting circuit 114. The light-emitting circuit 114 provides a lighting effect according to a control signal SC. In some embodiments, the light-emitting circuit 114 may be disposed around the buttons 111_1~111_N. When a button is pressed, the color of the light around the pressed button may differ from the color of the light around an unpressed button.

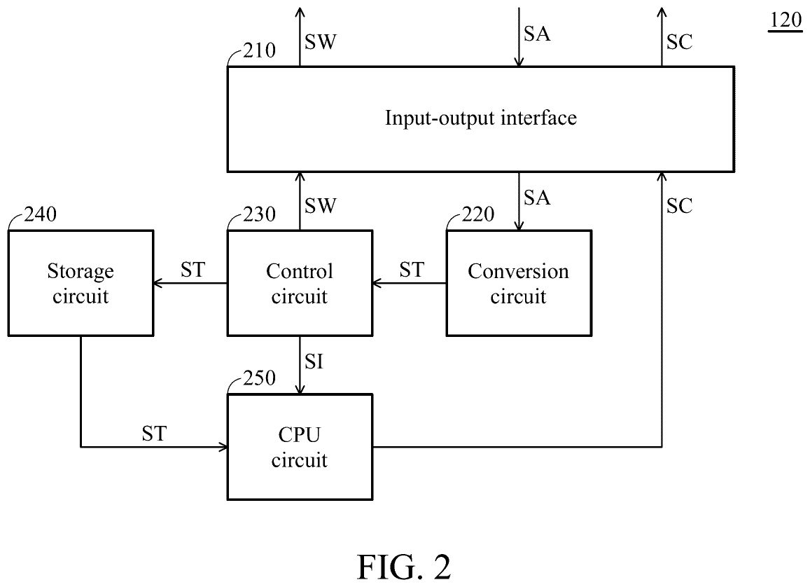

FIG. 2 is a schematic diagram of an exemplary embodiment of a microcontroller according to various aspects of the present disclosure. The microcontroller 120 comprises an input-output interface 210, a conversion circuit 220, a control circuit 230, a storage circuit 240, and a central processing unit (CPU) circuit 250. The input-output interface 210 outputs the switching signal SW and receives the sampled signal SA. In one embodiment, the input-output interface 210 has at least one general-purpose input-output (GPIO) pin for outputting the switching signal SW. For example, when the switching signal SW is a digital value with three bits, the input-output interface 210 uses three GPIO pins to output the switching signal SW.

The conversion circuit 220 converts the sampled signal SA to generate a converted signal ST. In one embodiment, the conversion circuit 220 is an analog-to-digital converter (ADC) to convert the sampled signal SA from an analog format to a digital format. In this case, the converted signal ST is a digital signal.

The control circuit 230 generates and adjusts the switching signal SW so that the external device 110 outputs the sampled signals from different channels. For example, when the control circuit 230 sets the switching signal SW to have a first electrical characteristic, the external device 110 selects the channel CH1 to use the sampled signal SA_1 as the sampled signal SA. The input-output interface 210 transmits the sampled signal SA (i.e., the sampled signal SA_1) to the conversion circuit 220. The conversion circuit 220 converts the sampled signal SA (i.e., the sampled signal SA_1) to generate the converted signal ST (or referred to as a first converted signal). The control circuit 230 determines whether a specific event has occurred. When the specific event has not occurred, the control circuit 230 stores the first converted signal in the storage circuit 240 and adjusts the switching signal SW. In one embodiment, the control circuit 230 sets the switching signal SW to have a second electrical characteristic. The external device 110 uses the sampled signal SA_2 of the channel CH2 as the sampled signal SA according to the adjusted switching signal SW (having a second electrical characteristic). The input-output interface 210 transmits the sampled signal SA (i.e., the sampled signal SA_2) to the conversion circuit 220. The conversion circuit 220 converts the sampled signal SA (i.e., the sampled signal SA_2) to generate the converted signal ST (or referred to as a second converted signal). The control circuit 230 determines whether a specific event has occurred. When the specific event has not occurred, the control circuit 230 stored the second converted signal in the storage circuit 240 and re-adjusts the switching signal SW. In one embodiment, the control circuit 230 sets the switching signal SW to have a third electrical characteristic. The type of control circuit 230 is not limited in the present disclosure. In one embodiment, the control circuit 230 is a peripheral direct memory access (PDMA) circuit.

However, when a specific event occurs, the control circuit 230 first writes the output of the conversion circuit 220 to the storage circuit 240, and then enables an interrupt signal SI. In one embodiment, the specific event refers to the conversion circuit 220 completing the conversion operation for all sampled signals (such as SA_1~SA_N) of the external device 110. In another embodiment, the specific condition refers to the external device 110 having output all sampled signals SA_1~SA_N. In some embodiments, the specific event refers to the electrical characteristic of the switching signal SW meeting a first predetermined value, or the number of times that the switching signal SW is adjusted by the control circuit 230 arriving a second predetermined value.

The storage circuit 240 stores the converted signals ST. When interrupt signal SI is enabled, the CPU circuit 250 operates according to all converted signals ST stored in the storage circuit 240. In one embodiment, the CPU circuit 250 determines the pressed states of the buttons 111_1~111_N according to all converted signals ST stored in the storage circuit 240. In another embodiment, the CPU circuit 250 converts the force with which each of the buttons 111_1~111_N is pressed. In some embodiments, the CPU circuit 250 generates the control signals SC according to all converted signals ST stored in storage circuit 240 to control the lighting effect of the external device 110.

In this embodiment, the external device 110 outputs all sampled signals SA_1~SA_N according to the switching signal SW generated and adjusted by the control circuit 230. When the external device 110 outputs the sampled signal SA and the conversion circuit 220 converts the sampled signal SA, the CPU circuit 250 is not required to intervene the operations of the external device 110 and the conversion circuit 220. Since the CPU circuit 250 does not need to generate the switching signal SW, it has more time to perform other operations, such as controlling the lighting effect of the external device 110, determining the pressed states of the buttons 111_1~111_N, or converting the force with which each of the buttons 111_1~111_N is pressed.

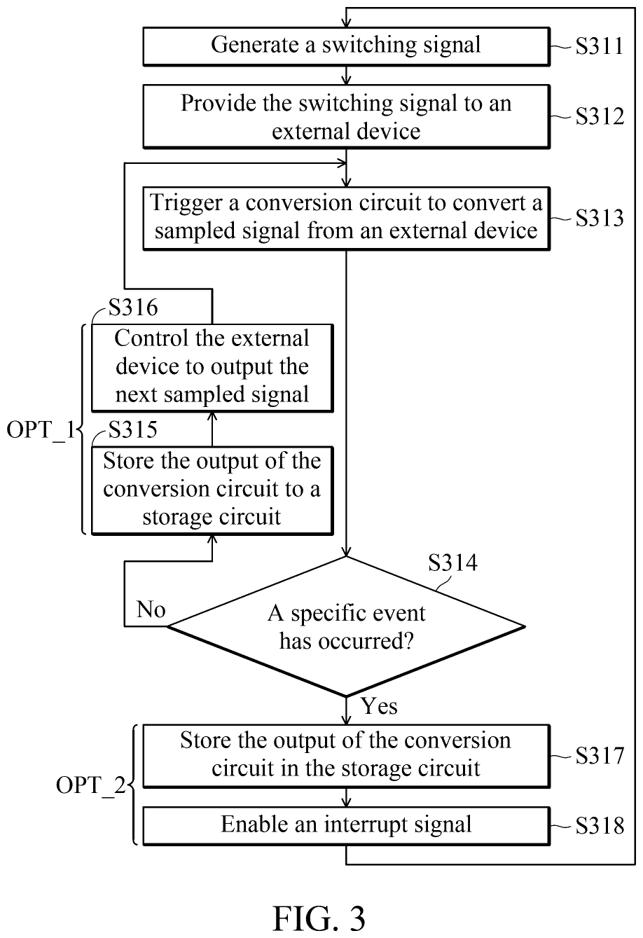

FIG. 3 is a flowchart of an exemplary embodiment of a control method in accordance with an embodiment of the present disclosure. The control method of the present disclosure can be implemented using the microcontroller and the control circuit shown in FIG. 2. Alternatively, the control method of the present disclosure can exist as program code. When the program code is loaded and executed by a machine, the machine becomes the microcontroller and the control circuit for practicing the control method.

First, a switching signal is generated (step S311). In one embodiment, the switching signal is generated by a PDMA circuit. Then, the switching signal is provided to an external device (step S312). In one embodiment, the PDMA circuit outputs the switching signal to an external device through at least one general-purpose input-output pin.

Next, a conversion circuit is triggered to convert a sampled signal from an external device (step S313). In one embodiment, the sampled signal is an analog signal. The conversion circuit converts the sampled signal into a digital signal. In this case, the conversion circuit is an ADC. In another embodiment, the sampled signal is a digital signal. In this case, the conversion circuit may convert the sampled signal into an analog signal, or convert the voltage level of the sampled signal, such as increasing or decreasing the voltage level of the sampled signal.

The PDMA circuit determines whether a specific event has occurred (step S314). In one embodiment, the specific event is that the electrical characteristic of the switching signal are equal to a predetermined value. When the specific event has not occurred, it indicates that the external device has not yet output all sampled signals. Therefore, the PDMA circuit performs an operation OPT_1.

The operation OPT_1 comprises storing the output of the conversion circuit to a storage circuit (step S315) and controlling the external device to output the next sampled signal (step S316). The present disclosure does not limit how the PDMA circuit controls the external device to output the next sampled signal. In one embodiment, the PDMA circuit adjusts the electrical characteristic of the switching signal. In this case, the external device outputs sampled signals for different channels according to the switching signals with different electrical characteristics.

Next, the conversion circuit is triggered to convert the next sampled signal from the external device (step S313), and a determination is made as to whether a specific event has occurred (step S314). When the specific event occurs, it indicates that the external device has output all sampled signals. Therefore, the PDMA circuit performs an operation OPT_2.

The operation OPT_2 comprises storing the output of the conversion circuit in the storage circuit (step S317) and enabling an interrupt signal (step S318). In one embodiment, when the interrupt signal is enabled, the CPU circuit performs a specific operation according to the data stored in the storage circuit, such as controlling the lighting effect of an external device or converting the data stored in the storage circuit.

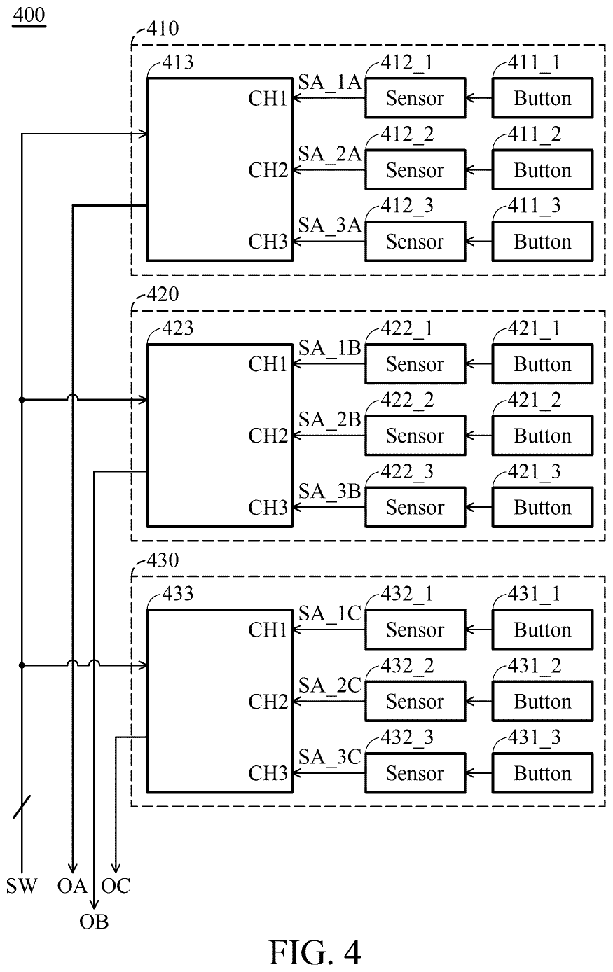

FIG. 4 is a schematic diagram of an exemplary embodiment of an external device according to various aspects of the present disclosure. As shown in FIG. 4, the external device 400 comprises operation groups 410, 420, and 430. The number of operation groups is not limited in the present disclosure. In other embodiments, the external device 400 has more or fewer operation groups. The operation group 410 comprises buttons 411_1~411_3, sensors 412_1~412_3, and a switch circuit 413. Since the characteristics of the buttons 411_1~411_3 and the sensors 412_1~412_3 shown in FIG. 4 are similar to the characteristics of the button 111_1 and the sensor 121_1 shown in FIG. 1, the related description is omitted here. The switch circuit 413 comprises channels CH1~CH3. The channels CH1~CH3 respectively receive the sampled signals SA_1A~SA_3A generated by the sensors 412_1~412_3. The switch circuit 413 selects one of the sampled signals SA_1A~SA_3A as the output signal OA according to the switching signal SW.

The number of buttons and sensors in the operation group 410 is not limited in the present disclosure. In other embodiments, the operation group 410 has other numbers of buttons and sensors. In this case, the switching circuit 413 comprises more channels or fewer channels. Each channel receives a sampled signal from a corresponding sensor.

The operation group 420 comprises buttons 421_1~421_3, sensors 422_1~422_3, and a switch circuit 423. The operation group 430 comprises buttons 431_1~431_3, sensors 432_1~432_3, and a switch circuit 433. Since the characteristics of the operation groups 420 and 430 are similar to the characteristic of the operation group 410, the related description is omitted here.

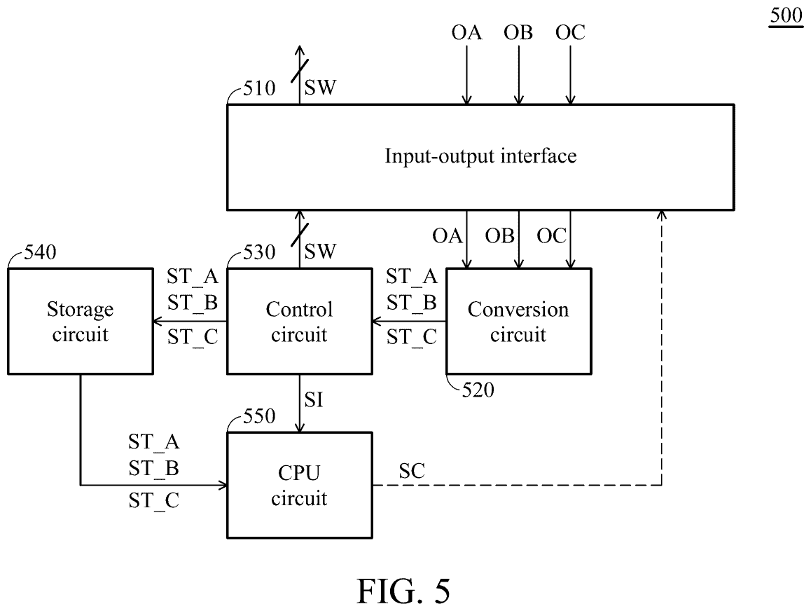

FIG. 5 is a schematic diagram of another exemplary embodiment of the microcontroller according to various aspects of the present disclosure. The microcontroller 500 comprises an input-output interface 510, a conversion circuit 520, a control circuit 530, a storage circuit 540, and a CPU circuit 550. The input-output interface 510 outputs a switching signal SW and receives the output signals OA~OC. Since the characteristic of the input-output interface 510 is similar to the characteristic of the input-output interface 210 in FIG. 2, the related description is omitted here.

The control circuit 530 generates a switching signal SW and provides the switching signal to the input-output interface 510. In one embodiment, the control circuit 530 sets the electrical characteristic of switching signal SW to control the switching circuits 413, 423, and 433 to select the corresponding channels. For example, when the switching signal SW is a digital value 001, the switching circuits 413, 423, and 433 select the sampled signals SA_1A, SA_1B, and SA_1C of the channels CH1 as the output signals OA~OC. When the switching signal SW is a digital value 011, the switching circuits 413, 423, and 433 select the sampled signals SA_2A, SA_2B, and SA_2C of the channels CH2 as the output signals OA~OC. When the switching signal SW is a digital value 111, the switching circuits 413, 423, and 433 select the sampled signals SA_3A, SA_3B, and SA_3C of the channels CH3 as the output signals OA~OC.

The conversion circuit 520 sequentially converts the output signals OA~OC to generate the converted signals ST_A~ST_C. The control circuit 530 writes the converted signals ST_A~ST_C to the storage circuit 540. In other embodiments, the conversion circuit 520 directly writes the converted signals ST_A~ST_C to the storage circuit 540. In some embodiments, the conversion circuit 520 comprises three converters (not shown) that convert the output signals OA~OC respectively.

The control circuit 530 determines whether the electrical characteristic of the switching signal SW is equal to a predetermined value (e.g., 1111). When the electrical characteristic of the switching signal SW is not equal to a predetermined value, the control circuit 530 continues to set the electrical characteristic of the switching signal SW to require the external device to output another corresponding sampled signal. When the electrical characteristic of the switching signal SW is equal to a predetermined value, the control circuit 530 waits for the conversion circuit 520 to complete the conversion operation for the output signals OA~OC, writes the output of conversion circuit 520 to the storage circuit 540, and then enables the interrupt signal SI.

When the interrupt signal SI is enabled, the CPU circuit 550 operates according to the data stored in the storage circuit 540. In one embodiment, the CPU circuit 550 converts the data stored in the storage circuit 540. In another embodiment, the CPU circuit 550 determines the pressed states of the buttons 411_1~411_3, 421_1~421_3, and 431_1~431_3 of the external device 400 according to the data stored in the storage circuit 540. The CPU circuit 550 performs a specific operation according to the pressed state of the buttons 411_1~411_3, 421_1~421_3, and 431_1~431_3. In one embodiment, the specific operation generates a control signal SC to control the lighting effect of a light-emitting circuit (not shown) of the external device 400.

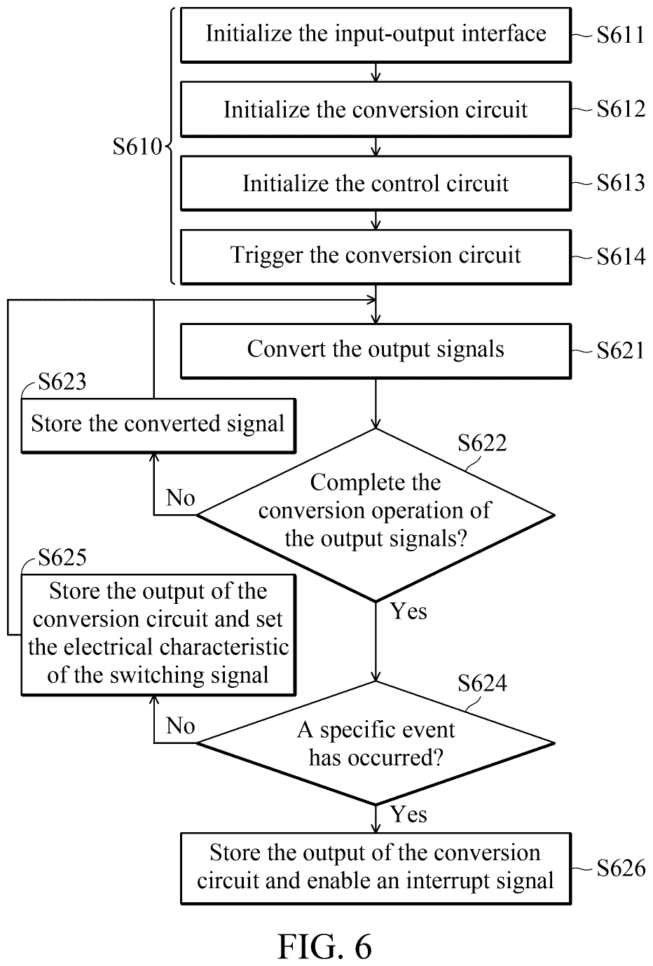

FIG. 6 is a flowchart of another exemplary embodiment of the control method in accordance with an embodiment of the present disclosure. The control method of the present disclosure can be implemented using the microcontroller and the control circuit shown in FIG. 5. Alternatively, the control method of the present disclosure can exist as program code. When the program code is loaded and executed by a machine, the machine becomes the microcontroller and the control circuit for practicing the control method.

First, an initial operation S610 is performed. The initial operation S610 comprises steps S611~S614. Step S611 is performed to initialize the input-output interface 510. After initialization, the input-output interface 510 transmits a switching signal SW via at least one GPIO pin. For example, when the switching signal SW is a 3-bits digital value, the input-output interface 510 transmits the switching signal SW using three GPIO pins. In other embodiments, the input-output interface 510 receives the output signals OA~OC using three pins.

Step S612 is performed to initialize the conversion circuit 520. After initialization, the conversion circuit 520 is ready to perform an analog-to-digital conversion operation. Step S613 is performed to initialize the control circuit 530. In one embodiment, after initialization, the control circuit 530 sets the switching signal SW to an initial digital value, such as 001. In this case, when the external device 400 receives the switching signal SW, the switching circuits 413, 423, and 433 use the sampled signals SA_1A, SA_1B, and SA_1C of the channels CH1 as the output signals OA~OC.

Step S614 is performed to trigger the conversion circuit 520. The conversion circuit 520 begins to convert the output signals OA~OC (such as the sampled signals SA_1A, SA_1B and SA_1C of the channels CH1 of switching circuits 413, 423 and 433) (step S621).

After converting the output signal OA (such as the sampled signal SA_1A of the channel CH1 of the switch circuit 413), the conversion circuit 520 generates the converted signal ST_A. The control circuit 530 determines whether the conversion circuit 520 has completed the conversion operation of the output signals OA~OC (step S622). Since the conversion circuit 520 does not converted the output signals OB and OC, the control circuit 530 stores the converted signal ST_A (step S623) and returns to step S621, requesting the conversion circuit 520 to convert the output signals OB and OC, such as the sampled signal SA_1B of the channel CH1 of the switch circuit 423 and the sampled signal SA_1C of the channel CH1 of the switch circuit 433.

When the conversion circuit 520 completes the conversion operation of the output signals OA~OC (such as the sampled signals SA_1A, SA_1B and SA_1C of the channels CH1 of the switching circuits 413, 423 and 433), the control circuit 530 determines whether a specific event has occurred (step S624). In one embodiment, the specific condition refers to the switching signal SW being equal to a predetermined value.

When the specific event does not occur, it indicates that the external device has not yet output the sampled signals for all channels. Therefore, the control circuit 530 stores the output of the conversion circuit 520 and sets the electrical characteristic of the switching signal SW (step S625), such as switching from the digital value 001 to 011.

When a specific event occurs, it indicates that the external device has output the sampled signals from all channels. Therefore, the control circuit 530 stores the output of the conversion circuit 520 and enables an interrupt signal (step S626). In one embodiment, when the interrupt signal is enabled, a CPU circuit operates according to the converted signal stored in the control circuit 530. In some embodiments, the control circuit 530 writes the converted signal to a storage circuit. In this case, the CPU circuit may determine or convert the data in the storage circuit.

The control circuit provides the switching signals to control the switch circuit of the external device and stores the output of the conversion circuit. Therefore, the CPU circuit does not need to intervene in the operation of the external device. After the external device outputs all sampled signals and the conversion circuit completes the conversion operation, the control circuit enables the interrupt signal. The CPU circuit then operates according to the data stored in the storage circuit. The CPU circuit can perform other operations before the external device outputs all sampled signals, thus improving its efficiency.

It will be understood that when an element or layer is referred to as being “on”, “connected to” or “coupled to” another element or layer, it can be directly on, connected or coupled to the other element or layer or intervening elements or layers may be present. In contrast, when an element or layer is referred to as be “directly on”, “directly connected to” or “directly coupled to” another element or layer, there are no intervening elements or layers present.

Control method may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes a microcontroller and a control circuit for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes a microcontroller and a control circuit for practicing the disclosed methods. When implemented on a general-purpose processor, the program code combines with the processor to provide a unique apparatus that operates analogously to application-specific logic circuits.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. A microcontroller coupled to an external device which provides a plurality of sampled signals, comprising:
an input-output interface outputting a switching signal to the external device and receiving the sampled signals;
a conversion circuit converting the sampled signals to generate a plurality of converted signals;
a control circuit generating and adjusting the switching signal;
a storage circuit storing the converted signals; and
a central processing unit (CPU) circuit operating according to the converted signals stored in the storage circuit in response to an interrupt signal being enabled,
wherein in response to a specific event occurring, the control circuit enables the interrupt signal.

2. The microcontroller as claimed in claim 1, wherein the control circuit is a peripheral direct memory access (PDMA) circuit.

3. The microcontroller as claimed in claim 2, wherein the conversion circuit is an analog-to-digital converter (ADC).

4. The microcontroller as claimed in claim 3, wherein in response to the sampled signals having been converted by the conversion circuit, the control circuit enables the interrupt signal.

5. The microcontroller as claimed in claim 3, wherein the input-output interface comprises a plurality of general-purpose input-output (GPIO) pins to output the sampled signals.

6. The microcontroller as claimed in claim 3, wherein in response to the interrupt signal being enabled, the CPU circuit controls a lighting effect of the external device according to the converted signals stored in the storage circuit.

7. The microcontroller as claimed in claim 1, wherein the control circuit stores the converted signals in the storage circuit.

8. The microcontroller as claimed in claim 1, wherein:
the control circuit generates the switching signal,
the external device outputs a first sampled signal of the sampled signals according to the switching signal,
the input-output interface transmits the first sampled signal to the conversion circuit,
the conversion circuit converts the first sampled signal to generate a first converted signal of the converted signals,
the control circuit determines whether the specific event occurs,
in response to the specific event occurring, the control circuit stores the first converted signal in the storage circuit and adjusts the switching signal.

9. The microcontroller as claimed in claim 8, wherein:
the external device outputs a second sampled signal of the sampled signals according to the adjusted switching signal,
the input-output interface transmits the second sampled signal to the conversion circuit,
the conversion circuit converts the second sampled signal to generate a second converted signal of the converted signals,
the control circuit determines whether the specific event occurs,
in response to the specific event not occurring, the control circuit stores the second converted signal in the storage circuit and adjusts the switching signal again.

10. The microcontroller as claimed in claim 9, wherein in response to an electrical characteristic of the switching signal being equal to a predetermined value, the control circuit enables the interrupt signal.

11. A control system, comprising:
an external device comprising:
a plurality of buttons;
a plurality of sensors, each detecting a pressed state of one of the buttons to generate a sampled signal;
a switch circuit outputting the sampled signals according to a switching signal;
a microcontroller comprising:
an input-output interface outputting the switching signal to the switch circuit and receiving the sampled signals;
a conversion circuit converting the sampled signals to generate a plurality of converted signals;
a control circuit generating and adjusting the switching signal;
a storage circuit storing the converted signals; and
a CPU circuit operating according to the converted signals stored in the storage circuit in response to an interrupt signal being enabled,
wherein in response to a specific event occurring, the control circuit enables the interrupt signal.

12. The control system as claimed in claim 11, wherein the buttons are magnetic-axis buttons, the sensors are Hall sensors, and the switch circuit is an analog switch.

13. The control system as claimed in claim 12, wherein the control circuit is a PDMA circuit.

14. The control system as claimed in claim 13, wherein the conversion circuit is an ADC.

15. The control system as claimed in claim 14, wherein the external device further comprises:
a light-emitting circuit providing a lighting effect,
wherein in response to the interrupt signal being enabled, the CPU circuit controls the lighting effect according to the converted signals stored in the storage circuit.

16. The control system as claimed in claim 14, wherein in response to an electrical characteristic of the switching signal being equal to a predetermined value, the control circuit enables the interrupt signal.

17. A control method for a PDMA circuit, comprising:
generating a switching signal;
providing the switching signal to an external device;
triggering a conversion circuit to convert the first sampled signal from the external device;
determining whether a specific event occurs;
in response to the specific event not occurring:
storing the output of the conversion circuit to a storage circuit;
controlling the external device to output a second sampled signal;
converting the second sampled signal; and
determining whether the specific event occurs; and
in response to the specific event occurring:
storing the output of the conversion circuit in the storage circuit; and
sending an interrupt signal to a CPU circuit so that the CPU circuit operates according to the data stored in the storage circuit.

18. The control method as claimed in claim 17, wherein the CPU circuit controls a lighting effect of the external device according to the data stored in the storage circuit.

19. The control method as claimed in claim 17, wherein the step of controlling the external device to output the second sampled signal comprises:
adjusting the switching signal.

20. The control method as claimed in claim 19, wherein the first sampled signal is an analog signal, and the output of the converted signal is a digital signal.
